(19) United States
(12) Patent Application Publication
(10) Pub. No.: US 2020/0181316 A1
(43) Pub. Date: Jun. 11, 2020

(54) SPRAY APPLIED REINFORCED EPOXY

(71) Applicant: Warren Environmental & Coating, LLC, Middleborough, MA (US)

(72) Inventor: Philip Warren, Carver, MA (US)

(21) Appl. No.: 16/212,162

(22) Filed: Dec. 6, 2018

(51) Int. Cl. C08G 59/06; C08K 3/013; C08K 3/04; C08G 59/50; C08L 83/04; B05D 1/02; B05D 3/10

(52) U.S. Cl. CPC C08G 59/063; C08K 3/013; C08K 3/042; C08G 59/5026; B05D 2504/00; B05D 1/02; B05D 3/108; C08K 2201/005; C08L 83/04

(57) ABSTRACT

A composition and method for spray-applying a two-part, self-setting composition containing a structural reinforcement component that is particularly adapted for delivering the components of the composition at a temperature that promotes their spray application as well as a self-setting reaction. The method includes selecting a self-setting compound that is adapted for curing in place once applied, the self-setting compound including at least one reinforcing material; and applying the compound to a substrate. Alternately, a self-curing compound includes a multi-part compound which, upon a mixing of the parts, chemically reacts and cures, and at least one reinforcing material dispersed into at least one of the parts, wherein the reinforcing material enhances the strength of the coating upon application of the compound.

### BACKGROUND OF THE INVENTION

The present invention generally relates to a composition and method for spray-applying a two-part, self-setting composition containing reinforcement material that provides desired properties such as additional strength. More specifically, the present invention relates to a method and system for spray applying a composition that contains a reinforcing component and is particularly adapted for delivering the components of the composition at a temperature that promotes their spray application as well as a self-setting reaction.

Polymer compositions are being increasingly used in a wide range of areas that have traditionally employed the use of other materials, such as metals. Polymers possess a number of desirable physical properties, are light weight, and inexpensive. In addition, many polymer materials may be formed into a number of various shapes and forms and exhibit significant flexibility in the forms that they assume, and may be used as coatings, dispersions, extrusion and molding resins, pastes, powders, and the like.

Generally, epoxy coatings are well known in the art and due to their exceptional durability and structural properties epoxy based protective coatings have gained commercial acceptance as protective and decorative coatings for use on a wide variety of materials. For example, epoxy based protective coatings represent one of the most widely used methods of corrosion control. They are used to provide long term protection of steel, concrete, aluminum and other structures under a broad range of corrosive conditions, extending from atmospheric exposure to full immersion in highly corrosive environments. Further, epoxy coatings are readily available and are easily applied by a variety of methods including spraying, rolling and brushing. They adhere well to steel, concrete and other substrates, have low moisture vapor transmission rates and act as barriers to water, chloride and sulfate ion ingress, provide excellent corrosion protection under a variety of atmospheric exposure conditions and have good resistance to many chemicals and solvents. As a result, numerous industries including maintenance, marine, construction, architectural, aircraft and product finishing have adopted broad usage of epoxy coating materials.

The most common material utilized in the epoxy coating industry today is a multi-part epoxy material. In general, the epoxy includes a first base resin matrix and at least a second catalyst or hardener, although other components such as a pigment agent or an aggregate component may also be added. While the two parts remain separate, they remain in liquid form. After the two parts are mixed together, they begin a curing process that is typically triggered by exposure to heat, humidity or a ultra-violet light source, whereby the mixed material quickly begins to solidify. As a result, it is necessary to mix only a sufficient amount of compound such that it can be worked effectively before setting up occurs. Accordingly, the use and application of these compounds is a tedious, slow and expensive proposition.

There are various applications for which it would be desirable to use polymer compositions, which require materials with strength properties equivalent to metals. However, a significant number of polymeric materials fail to be intrinsically strong enough for many of these applications.

For example. in the manufacture of a wide variety of fibrous-reinforced parts (e.g., FRP or fiber glass reinforced parts), it would be desirable to spray apply an unsaturated resin (catalyzed, heat-curable, unsaturated polyester resin) which would contain a high loading of reinforcing material. In the prior art this is done with (e.g., say, 55% to 75% by weight) of reinforcing fiber (e.g., ceramic fiber like wollastinite fibers of 0.0017 to 0.0059 mm in average particle diameter with aspect ratios of from about 5 to 17). Unfortunately, conventional spray equipment will not properly spray such resins with such high fiber loadings. The spray equipment, especially the spray guns, become plugged easily by the ceramic fibers which makes down time of the equipment particularly troublesome at commercial operations. It is troublesome enough to spray conventional catalyzed unsaturated resins because of premature gelation problems, cleaning of the equipment during down time cycles, and the like. To add a high loading of ceramic fiber means that the equipment would have to spray a resin mix having the consistency of oatmeal, and a mix that is quite abrasive due to the ceramic fiber content.

One approach to solving the problem of air void surface defects in FRP parts involves the spraying of ceramic fiber-loaded resins over a layer of gel coat which covers the mold. Such a process is limited in its ability to spray high loadings of ceramic fiber (a mixture of calcium silicate and mica). Still, the need for being able to spray resins with high ceramic fiber loadings is underscored by this patent.

There has been some advancement in applications technology, such as systems for controlling mixing and viscosity. While these systems have provided great advancements in use of some sealing compounds, there is still great room for improvement. One example of an improvement discloses a spray application system and method for a two-part, self-setting compound, and provides needed advancement of application technology, opportunities for improvement remain. For example, in some instances, multiple coats of compound may be required. More specifically, due to the nature of a mixture of compounds that may be in use, a desired finish may not be attainable if the compounds are applied too thickly. Applying multiple coats necessarily requires additional time and energy, and therefore can be costly.

In contrast, attempts to apply a thick coating typically result in slumping of compound and may require considerable rework. In some environments, such as with underground piping, misapplication can be virtually disastrous.

In short, now that techniques for applications have been greatly improved, there are opportunities to further refine compounds suited for various applications. Thus, what is needed are methods and apparatus for efficiently applying reinforced compounds in a production environment. Preferably, the methods and apparatus provide for a much thicker reinforced coating of material than previously achievable. Further, it is desirable to have methods and apparatus that enhance the variety of reinforced sealing compounds that may be applied and the increase applications for which the compounds may be used.

In view of the foregoing, there is a need for a method and system for spray-applying a two-part, self-setting composition containing a reinforcement material that provides desired properties. Further, there is a need for a method and system for spray applying a composition that contains a reinforcing component and is particularly adapted for delivering the components of the composition at a temperature that promotes their spray application as well as a self-setting reaction.

### BRIEF SUMMARY OF THE INVENTION

In this regard, the present invention relates to a composition and method for spray-applying a two-part, self-setting composition containing a reinforcing component and is particularly adapted for delivering the components of the composition at a temperature that promotes their spray application as well as a self-setting reaction. Further, the present disclosure provides a graphene-reinforced polymer composite wherein well-crystallized graphite particles are dispersed in a resin prepared for spray application in an manner that improves the mechanical properties of the bulk polymer.

Generally, the compound includes two liquid portions which are both very viscous and therefore difficult to pump. It has been found that the portions are easier to pump, and therefore easier to deliver to the spray device, if they are heated within the storage containers, and maintained in such a state all the way to the spray tip. This also facilitates more volumetrically-controlled delivery of each of the two portions of the compound to the spray device. Accordingly, the system generally includes means for heating the contents of the containers that hold the two parts of the compounds, for example by using temperature-controlled heaters. Recirculating pumps may be used in the containers to ensure mixing and uniform heating of the two portions. The heated hose may be heated by including an electrical resistance heating element for the hose and then using a temperature controlled power supply for the electrical resistance heating element to maintain an elevated compound temperature in the heated hose. The hoses may also be heated with steam. The hoses that carry the liquids from the containers to the mixing assembly should be insulated or possibly heated themselves as necessary to maintain the portions at an elevated temperature, so they flow better, and for volume control at the spray gun.

The pumping means for each of the two portions of the compound may include a low pressure pump for drawing the portions out of the containers. Each of the pumping means may further include high pressure pumps, fed from the low-pressure pumps, for elevating the pressure of the two portions delivered to the mixing assembly. The pumps are preferably positive displacement pumps which deliver carefully controlled volumes of each of the portions to the mixing assembly so that the compound is mixed in the ratio required to cure properly as set forth in the manufacturer's specification.

The mixing assembly preferably includes a static mixer with a mixing block upstream of the static mixer. There may further be included flow control valves upstream of the mixing assembly. The valves may be mechanically linked to operate in unison. There may also be included means for flushing the mixing assembly, hose and spray device. Flushing may be accomplished with a source of flushing solvent under pressure.

One aspect of the invention is directed to a graphene-reinforced polymer matrix composite comprising an essentially uniform distribution in one of the liquid components of the two part epoxy composition of between about 10% wt and about 50% wt, preferably about 20% wt to about 40% wt, more preferably about 25% wt to about 35% wt, and most preferably about 30% to about 35% wt of total composite weight of particles selected from the group consisting of graphite microparticles, single-layer graphene nanoparticles, multi-layer graphene nano particles, and combinations of two or more thereof.

Another aspect of the invention is directed to a graphene-reinforced polymer matrix composite as disclosed above, wherein the composite is prepared by a method comprising the steps of:

(a) distributing graphite microparticles into a resin portion of one or more of said matrix polymers;

(b) providing a catalyst/activator;

(c) supplying said resin and catalyst at an elevated temperature to a mixing assembly to mix said reinforced resin and catalyst into a polymer composition; and

(d) spray applying said reinforced polymer composition to a substrate.

In one embodiment the graphite particles are prepared by crushing and grinding a graphite-containing mineral to millimeter-sized dimensions, reducing the millimeter-sized particles to micron-sized dimensions, and extracting micron-sized graphite particles from the graphite-containing mineral.

Therefore, it is an object of the present invention to provide a method and system for spray-applying a two-part, self-setting composition containing a reinforcing material that provides desired properties. Further, there is an object of the present invention to provide a method and system for spray applying a composition that contains a reinforcing component and is particularly adapted for delivering the components of the composition at a temperature that promotes their spray application as well as a self-setting reaction.

These together with other objects of the invention, along with various features of novelty which characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### DETAILED DESCRIPTION OF THE INVENTION

Disclosed herein are methods and apparatus for spray application of self-setting polymer compounds. In some embodiments, the self-setting composition that may include, for example, a two-part composition. One example includes an epoxy resin part with an appropriate activator part. Generally, such compounds generate heat during curing, where the epoxy resin chemically reacts with the activator. In some embodiments disclosed herein, the composition includes an appropriate reinforcing material dispersed therein to provide additional strength for the coating as applied.

As used in this document, the singular forms “a,” “an,” and “the” include plural reference unless the context clearly dictates otherwise. Unless defined otherwise, all technical and scientific terms used herein have the same meanings as commonly understood by one of ordinary skill in the art. All publications mentioned in this document are incorporated by reference. All sizes recited in this document are by way of example only, and the invention is not limited to structures having the specific sizes or dimensions recited below. Nothing in this document is to be construed as an admission that the embodiments described in this document are not entitled to antedate such disclosure by virtue of prior invention. As used herein, the term “comprising” means “including, but not limited to.”

The following term(s) shall have, for purposes of this application, the respective meanings set forth below:

As discussed herein, application of the composition will result in a “coating.” That is, generally, the composition is applied as a coating over an underlying substrate. However, it may be desirable, in some embodiments, to obtain cured composition that is separate from or free of the substrate. Therefore, merely as a matter of convention, cured composition is referred to herein as the “coating.” However, this is not to be construed as a requirement for a presence of an accompanying substrate.

A “substrate” may include any type of material that a user, designer, manufacturer or other interested party wishes to coat with the compound. The substrate may include, for example, at least one of concrete, metal, tar, wood, plastic and other common materials. The substrate may be at least one of smooth, rough, fragmented, continuous, irregular and the like. In some embodiments, the substrate is one of dry, moist, wet, and immersed in a liquid, such as water.

As discussed herein, a “reinforcing” generally refers to particulate matter that may be dispersed into the compound. The dispersing may be provided at any time in advance of application of the compound, as deemed appropriate. The reinforcing may include at least one type of particulate. For example, the reinforcing is preferably graphene for the purposes of this disclosure.

The term “graphene” refers to the name given to a single layer of carbon atoms densely packed into a fused benzene-ring structure. Graphene, when used alone, may refer to multilayer graphene, graphene flakes, graphene platelets, and few-layer graphene or single-layer graphene in a pure and uncontaminated form. The present invention provides a polymer composition that contains well-crystallized graphite particles in nano-dispersed single- or multi-layer graphene particles.

One aspect of the invention is directed to a graphene-reinforced polymer matrix composite comprising an essentially uniform distribution in one of the liquid components of the two part epoxy composition of between about 10% wt and about 50% wt, preferably about 20% wt to about 40% wt, more preferably about 25% wt to about 35% wt, and most preferably about 30% to about 35% wt of total composite weight of particles selected from the group consisting of graphite microparticles, single-layer graphene nanoparticles, multi-layer graphene nano particles, and combinations of two or more thereof.

In order to provide context for the teachings herein, a system for applying the compound, including embodiments of the compound with reinforcing dispersed therein are now introduced. This disclosure is not limited to the systems, methodologies or protocols described, as these may vary. The terminology used in this description is for the purpose of describing the particular versions or embodiments only and is not intended to limit the scope.

When attempting to spray apply an epoxy, two drawbacks are encountered. First, the material cannot be mixed in large batches prior to application because of the short pot life of the material. Accordingly, it must be mixed on an as needed basis immediately prior to spray application. Second, the naturally viscous consistency of the mixed epoxy material is not well suited for spray application, this is further exacerbated by the addition of the graphene reinforcing fillers.

To thin the epoxy to the consistency required for typical prior art spray application, the epoxy must be loaded with a large percent by volume of solvent. Such a solvent typically contains high level of volatile organic compounds (VOC) whose primary function is to lower viscosity thereby providing a consistency suitable for spray application with conventional air, airless and electrostatic spray equipment. The addition of the solvent to the epoxy coating material in turn greatly increases the VOC content of the epoxy coating material and reduces the build thickness of the finished and cured coating.

Exemplary embodiments of suitable reinforcing materials include graphene. Graphene in any form increases polymer toughness by inhibiting crack propagation as reinforcement for polymers. Graphene is a substance composed of pure carbon in which atoms are positioned in a hexagonal pattern in a densely packed one-atom thick sheet. This structure is the basis for understanding the properties of many carbon-based materials, including graphite, large fullerenes, nano-tubes, and the like (e.g., carbon nano-tubes are generally thought of as graphene sheets rolled up into nanometer-sized cylinders). Graphene is a single planar sheet of sp2 bonded carbon atoms. Graphene is not an allotrope of carbon because the sheet is of finite size and other elements can be attached at the edge in non-vanishing stoichiometric ratios. When used to reinforce polymers, graphene in any form increases polymer toughness by inhibiting crack propagation. Graphene can also be added to polymers and other compositions to provide electrical and thermal conductivity. The thermal conductivity of graphene makes it an ideal additive for thermal management (e.g., planar heat dissipation) for electronic devices and lasers. Some commercial applications of carbon fiber-reinforced polymer matrix composites (CF-PMCs) include aircraft and aerospace systems, automotive systems and vehicles, electronics, government defense/security, pressure vessels, and reactor chambers, among others.

Some exemplary benefits, selecting and controlling various concentrations and/or combinations of reinforcing materials may be used to control the curing process of the compound and therefore resultant coating properties. For instance, by making additions of a reinforcing material, the resultant coating is less likely to exhibit cracking. As another example, a thickness of an application of compound may be increased without a resulting slumping or rippling. Additional benefits may be realized in the application process, such as with an attendant reduction in pump pressure. Further, benefits may be realized with the final coating.

A system for applying a two or more-part, self-setting compound is provided. The system provides for spraying the compound onto surfaces, including wet surfaces. The spray application system includes a source of the first part of the compound and a source of the second part of the compound, for example containers up to the size of 55 gallon drums, or possibly larger containers as necessary to supply the desired amount of the parts for application. There is a spray device for applying the compound, and a mixing assembly for combining the two parts of the compound. A heated hose downstream of the mixing device delivers the compound to the spray device. There is a first pumping means, which may include one or more pumps, for delivering the first part of the compound to the mixing device, and a second pumping means, which also may include one or more pumps, for delivering the second part of the compound to the mixing device.

There are three types of epoxy resins that find application in the coating of water transport systems bisphenol A, bisphenol F, and novolac resins. These resins all result from reactions of epichlorohydrin with phenolic compounds. The type and number of phenolic groups determine both physical and performance properties of the cured resin.

Bisphenol A is a reaction product of phenol and acetone. Bisphenol A is reacted with epichlorohydrin to form diglycidylether bisphenol A resin or DGEBA. The resultant epoxy resin is a liquid with a honey-like consistency. DGEBA is most often used in solvent-free coatings and flooring systems. The molecular weight of the formulation is increased by adding more bisphenol A to liquid DGEBA to form semi-solid or solid resins. These resins are cut in solvent to allow their use as maintenance primers for steel or as corrosion-resistant films. Bisphenol A however is problematic in that it has been shown to leach significant pyproducts into the transported material.

Bisphenol F is similar to bisphenol A except phenol is reacted with formaldehyde rather than acetone. The resultant phenolic chemical does not have the two methyl groups that are present between the ring structures in bisphenol A resins. Bisphenol F is reacted with epichlorohydrin to form diglycidylether bisphenol F (DGEBF) resins. Because of the missing methyl groups, the viscosity of bisphenol F resins are typically ⅓ lower than the bisphenol A resins. Further the crosslinking is higher and as a result bisphenol F does not exhibit significant leaching and is therefore considered safe for food contact. However the lower viscosity typically results in a low functionality for spray application and heat and chemical resistance.

The present invention provides a spray applied reinforced coating formed using a bisphenol F resin that is formulated and mixed in such a manner that it allows spray application in high build coating while also exhibiting low sag. The base resin is preferably a Diglycidyl Ether of Bisphenol F resin. More preferably the resin is a low viscosity, liquid epoxy resin manufactured from epichlorohydrin and Bisphenol-F. The blended resin will exhibit improved crystallization resistance properties when compared to the neat, liquid, Bisphenol-A.

In addition to the base bisphenol F resin an air release agent is preferably employed to prevent foaming during mixing and application of the epoxy coating. This enhances application and provides a coating that is free from blisters and pinholes. Preferably an air release agent in the nature of a polysiloxane polymer blend is employed.

Also blended into the base resin is preferably the graphene reinforcing material.

Further, the coating material preferably includes a pigment such as a TiO2 to make application and verification of coating integrity easier.

The hardener component is preferably a cycloaliphatic amine. The hardener preferably does not contain phenol or benzyl alcohol. This facilitates a solvent free coating that is safe for food grade coatings.

In addition to the base hardener an air release agent is preferably employed to prevent foaming during mixing and application of the epoxy coating. This enhances application and provides a coating that is free from blisters and pinholes. Preferably an air release agent in the nature of a polysiloxane polymer blend is employed.

In the present invention the base resin including the reinforcing material and hardener components are fully blended separate and apart from one another. The two components are then maintained separated until ready for direct application to the surface. In the prior art, the materials were mixed in small batches for application and then the mixed batches were brush or roller applied. In some cases, the two components were mixed and then thinned or diluted with a solvent to a point where their viscosity allowed spray application. The difficulty in such cases is that the working time for the material is quite short once mixed requiring constant rebatching and, if spraying, cleaning of the spray equipment. Plus, the addition of significant solvents makes spray application in closed environments dangerous to the worker making the application. Finally, the viscosity required for spray application results in a coating that is too thin to apply as a high build coating.

Generally, the base resin and hardener components are both very viscous and therefore difficult to pump. It has been found that the portions are easier to pump, and therefore easier to deliver to the spray device, if they are heated in a closed environment within the storage containers, and maintained in such a state all the way to the spray tip. This also facilitates more volumetrically-controlled delivery of each of the two portions of the compound to the spray device.

Accordingly, the teachings of this invention provide that both the base resin and hardener, in anticipation of application be heated in a system generally includes means for heating the contents of the containers that hold the two components, for example by using temperature-controlled heaters. Recirculating pumps may be used in the containers to ensure mixing and uniform heating of the two portions. The heated hose may be heated by including an electrical resistance heating element for the hose and then using a temperature controlled power supply for the electrical resistance heating element to maintain an elevated compound temperature in the heated hose. The hoses may also be heated with steam. The hoses that carry the liquids from the containers to the mixing assembly should be insulated or possibly heated themselves as necessary to maintain the portions at an elevated temperature so they flow better, and for volume control at the spray gun.

The heated resin and hardener is mixed immediately prior to spray application in the sprayer itself. To reduce the viscosity of the components and enhance pumpability, the containers holding the resin and hardener components are maintained at an elevated temperature. Preferably, the components are maintained at about 170 degrees Fahrenheit to 220 degrees Fahrenheit. More preferably the components are maintained at about 180 degrees Fahrenheit to 190 degrees Fahrenheit.

It should be recognized that the teachings herein are merely illustrative and are not limiting of the invention. Further, one skilled in the art will recognize that additional components, configurations, arrangements and the like may be realized while remaining within the scope of this invention. For example, configurations and applications of dopants, curing time, layers and the like may be varied from embodiments disclosed herein. Generally, design and/or application of compounds and techniques for making use of the compounds are limited only by the needs of a system designer, manufacturer, operator and/or user and demands presented in any particular situation.

Various other components may be included and called upon for providing for aspects of the teachings herein. For example, additional materials, combinations of materials and/or omission of materials may be used to provide for added embodiments that are within the scope of the teachings herein.

When introducing elements of the present invention or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

In the present application a variety of embodiments are described. It is to be understood that any combination of any of these variables can define an embodiment of the invention. For example, a combination of a particular dopant material, with a particular compound, applied in a certain manner might not be expressly stated, but is an embodiment of the invention. Other combinations of articles, components, conditions, and/or methods can also be specifically selected from among variables listed herein to define other embodiments, as would be apparent to those of ordinary skill in the art.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A spray applied reinforced composition formed by the steps comprising:
providing a resin component at between 170 degrees Fahrenheit to 220 degrees Fahrenheit;
blending a reinforcing material into said resin component to form a reinforced resin component;
providing a hardener component at between 170 degrees Fahrenheit to 220 degrees Fahrenheit, said hardener component maintained separately from said reinforced resin component, and
mixing said reinforced resin component and hardener component to form a coating composition, wherein spray application of said coating composition to a substrate occurs immediately after mixing.

2. The reinforced composition of claim 1, the resin component comprising:
between 50% and 90% said bisphenol F resin by weight;
between 0.05% and 0.02% air release agent by weight; and
between 10% and 50% reinforcing material by weight.

3. The reinforced composition of claim 2, the resin component further comprising:
between 1% and 4% pigment by weight.

4. The reinforced composition of claim 1, the reinforced component comprising:
between 50% and 90% said bisphenol F resin by weight;
between 0.02% and 0.03% air release agent by weight,
between 10% and 50% thixotropic agent by weight; and
between 2% and 3% pigment by weight.

5. The reinforced composition of claim 1, the hardener component comprising:
between 80% and 99% said cycloaliphatic amine by weight; and
between 0.05% and 0.02% air release agent by weight.

6. The reinforced composition of claim 1, the hardener component comprising:
between 94% and 96% said cycloaliphatic amine by weight,
between 0.04% and 0.02% air release agent by weight; and
between 2% and 3% thixotropic agent by weight.

7. The reinforced composition of claim 1, the reinforcing material comprising:
graphite particles.

8. The reinforced composition of claim 1, the reinforcing material comprising:
nano sized graphite particles.

9. The reinforced composition of claim 1, the reinforcing material comprising:
graphene particles.
